(19) United States
(12) Patent Application Publication
(10) Pub. No.: US 2016/0162850 A1
(43) Pub. Date: Jun. 9, 2016

(54) SYSTEM AND METHOD FOR TRANSFERRING DIGITAL CURRENCY VIA PHYSICAL PRINT

(71) Applicant: Marshall Ware Van Alstyne, Newton, MA (US)

(72) Inventor: Marshall Ware Van Alstyne, Newton, MA (US)

(21) Appl. No.: 14/962,655

(22) Filed: Dec. 8, 2015

Related U.S. Application Data
(60) Provisional application No. 62/088,970, filed on Dec. 8, 2014.

(51) Int. Cl. G06Q 20/02; G06Q 30/02; G06Q 20/40

(52) U.S. Cl. CPC G06Q 20/023; G06Q 20/401; G06Q 30/0257; G06Q 30/0245

(57) ABSTRACT

A system and method for transferring digital currency via physical print is provided. The present invention includes a code generator. The code generator generates a computer readable code. The computer readable code includes information of an associated escrow account. The system of the present invention further includes a code reader and a display operatively connected with a computer. The code reader scans and reads the computer readable code. Once the code reader has scanned the computer readable code, a recipient account receives a monetary amount, i.e. a deposit, from the escrow account.

### CROSS-REFERENCE TO RELATED APPLICATION

This application claims the benefit of priority of U.S. provisional application No. 62/088,970, filed Dec. 8, 2014, the contents of which are herein incorporated by reference.

### BACKGROUND OF THE INVENTION

The present invention relates to system and method for transferring digital currency via physical print.

Print advertising has declined in both absolute and relative terms. Postal mail volume has fallen 20% since 2007. Newspaper revenues have plummeted over 40%. However, digital ads have experienced a compound annual growth rate of 17%. Growth in digital advertisements is so great that GOOGLE®, a company whose IPO occurred only 10 years ago, now earns more total revenue than all US newspapers and magazines combined.

At least three reasons account for these divergent advertising trends. Users cannot interact with paper in the same fashion they can interact with digital media. Content is static offline while it is dynamic online, making the digital experience superior. Information flows of traditional ads are 1-way outbound, from advertisers to consumers. This prevents users from expressing their preferences. They cannot indicate like or dislike for an ad while they can easily express such preferences online. In print, 1-way information flows also limit advertisers to push models of customer acquisition, as with a branding campaign, but prevent pull models of customer acquisition, as with a user's Google search. Digital systems permit parallel flows of money along with flows of information. PAYPAL®, AMAZON®, ALIPAY®, and now APPLE PAY® all allow purchasing to occur “on-platform” whereas print systems typically promote purchases “off-platform.” While it remains feasible to mail a check or go to a store in response to a print ad, an ability to conduct the transaction on-platform gives an online system an unfair advantage in terms of its ability to both observe consumer response and also take a cut of any transaction. Advertising expenditures have not declined; rather ads have shifted from print to digital.

As can be seen, there is a need for system and method for transferring digital currency via physical print.

### SUMMARY OF THE INVENTION

In one aspect of the present invention, a method of advertising a product or service comprises: generating a computer readable code by a sender via software executing on a first computer, wherein the computer readable code comprises account information of an escrow account and advertising information about the product or service; sending the computer readable code from the sender to at least one recipient; scanning the computer readable code by the at least one recipient via software executing on a second computer; producing the advertising information about the product or service to the at least one recipient via a display of the second computer; and transferring a monetary amount from the escrow account to a recipient account via software executing on a computer.

In another aspect of the present invention, a system for providing advertisements of a product or service comprising: a code generator that generates a computer readable code comprising account information of an escrow account and advertising information about the product or service; a code reader that reads the computer readable code; a computer operatively connected to the code reader and a display, wherein the computer receives the computer readable code from the code reader and produces the advertising information about the product or service on the display; and a recipient account receiving a monetary amount from the escrow account after the code reader reads the computer readable code.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention; and

FIG. 2 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

A hybrid print-digital advertisement system can readily compete with the above mentioned digital advertisements. The present invention is based on a new type of Redeemable Information Coupon (RIC) designed to engage consumers, combined with a digital platform designed to facilitate interaction. The printed coupon may encode five types of information—sender, recipient, content, expiration date, and coupon amount. The coupon may be instantly redeemable cash used to specifically target an individual consumer or consumer group. The cash reward could be anything from 1¢ to more than $100. The technology platform serves as a bridge between online and offline systems, lets users express their preferences, and facilitates complete transactions. The information could be embedded in a QR code, a signet code, or any other form of high-density print.

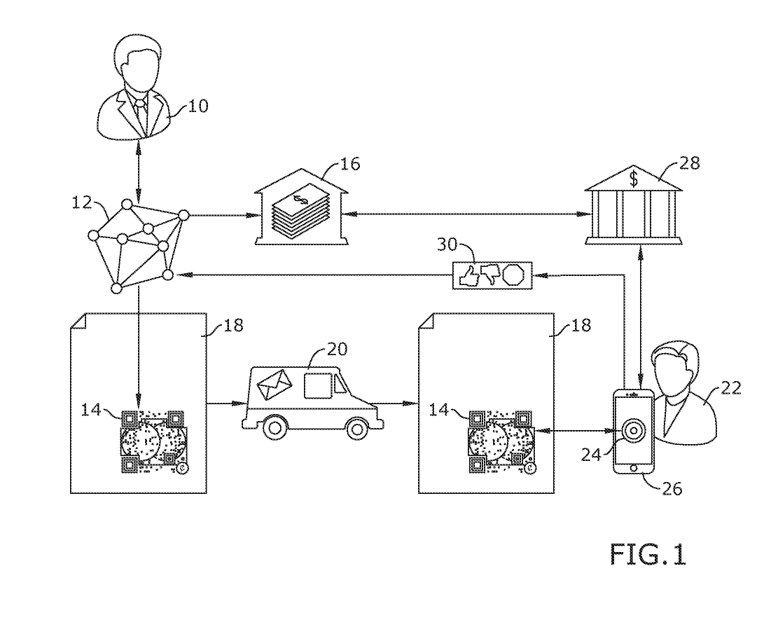

Referring to FIG. 1, the present invention includes a system for transferring currency via physical print. The present invention includes a code generator 12. The code generator 12 generates a computer readable code 14 (coupon). The computer readable code 14 includes account information of an escrow account 16. The system of the present invention further includes a code reader 24 and a display operatively connected with a computer 26. The code reader 24 scans and reads the computer readable code 14. Once the code reader 24 has scanned the computer readable code 14, a recipient account 28 receives a monetary amount, i.e. a deposit, from the escrow account 16.

The code generator 12 of the present invention may include software running on a first computer. A sender 10, such as a vendor, may use the first computer to generate the computer readable codes 14. The first computer may have access to a database. The database may include a list of targeted recipients 22, such as potential customers of the sender 10. As mentioned above, the computer readable codes 14 may be generated to include account information of an escrow account 16. The escrow account 16 is linked to and under the control of the sender 10.

The computer readable codes 14 may include any medium capable of storing data in a format readable by a machine. Examples of machine-readable media include magnetic media such as magnetic disks, cards, tapes, and drums, punched cards and paper tapes, optical disks, barcodes and magnetic ink characters. A barcode is an optical machine-readable representation of data relating to the object to which it is attached. In certain embodiments, the present invention may utilize a matrix barcode, such as a QUICK RESPONSE CODE™.

In certain embodiments, the computer readable codes 14 may include information about the target recipient 22. For example, the computer readable code 14 may include verifying information of the target recipient 22. Therefore, only the target recipient 22 is able to access the account information of the escrow account 16 and the advertising information about the product or service via the computer readable code. In such embodiments, the computer readable code 14 may be encrypted by the first computer and the second computer of the target recipient 22 may include software to decrypt the computer readable code 14. Further, the computer readable code 14 may be password protected, in which the recipient 22 enters a username and password to access the data on the computer readable code 14.

In certain embodiments, the computer readable codes 14 may include advertising information. The advertising information of the present invention may include information about the product or service, an option for the recipient to purchase the product or service, and an option for the recipient to provide feedback 30 of the product or service 30. For example, once the recipient 22 has scanned the computer readable code 14, the second computer may generate options for the recipient 22 to select, such as, but not limited to, an option to purchase the product or service using the internet and an option to provide feedback 30. The feedback 20 may include a selection of whether the recipient 22 is interested in the product or service being advertised, and whether the recipient 22 would like to continue to receive advertisements from the sender 10. The feedback 30 is then sent back to the sender 10 and saved in the database.

As mentioned above, the present invention includes an escrow account of the sender 10 and a recipient account 28 of the recipient 22. In certain embodiments, the recipient 22 may provide the recipient account 28 information, such as checking or savings account numbers and routing numbers, to the sender 10 prior to the generation of the computer readable code 14. In certain embodiments, the recipient 22 may sign up for a vendor account, such as a vendor credit card account, in which the monetary amount may be deposited. In certain embodiments, the sender 10 may create the recipient account 28 in which the recipient 22 may access once the computer readable code 14 has been scanned.

The computer readable code 14 of the present invention may be sent from the vendor 10 to the recipient 22 either electronically or by mail. For example, the computer readable code 14 may be sent via a text message, email, a cloud based database, and the like. In such embodiments, the computer readable code 14 is digitally displayed to the user. Alternatively, the computer readable code 14 may be physically printed onto a physical item 18, such as a letter. The letter is then mailed via a mail truck 20 and delivered directly to the recipient 22. The recipient 22 then opens the letter and is presented with the computer readable code 14.

The second computer 26 of the present invention may include any computer 26 that is operably connected to the code reader 24. For example, the computer 26 may include a desktop or laptop computer with a code reader 24, such as a camera or a bar code scanner, connected to the computer via USB or other connection. Alternatively, the computer 26 may be a smart device, such as a smart phone or tablet. In such embodiments, the smart device may use a camera as the code reader 24. The camera may capture an image of the computer readable code 14 and the computer may process the computer readable code to access the data.

In certain embodiments, the present invention may include an expiration date. The expiration date may be set by the sender 10 and may include a timeframe in which the target recipient 22 may retrieve funds from the escrow account 16. In such embodiments, the expiration date 10 may be set by including the expiration date within the data of the computer readable code 14. If the computer readable code 24 is scanned after the expiration date, the recipient may not retrieve the data stored on the computer readable code 24 and the monetary amount is not transferred from the escrow account 16 to the recipient account 28.

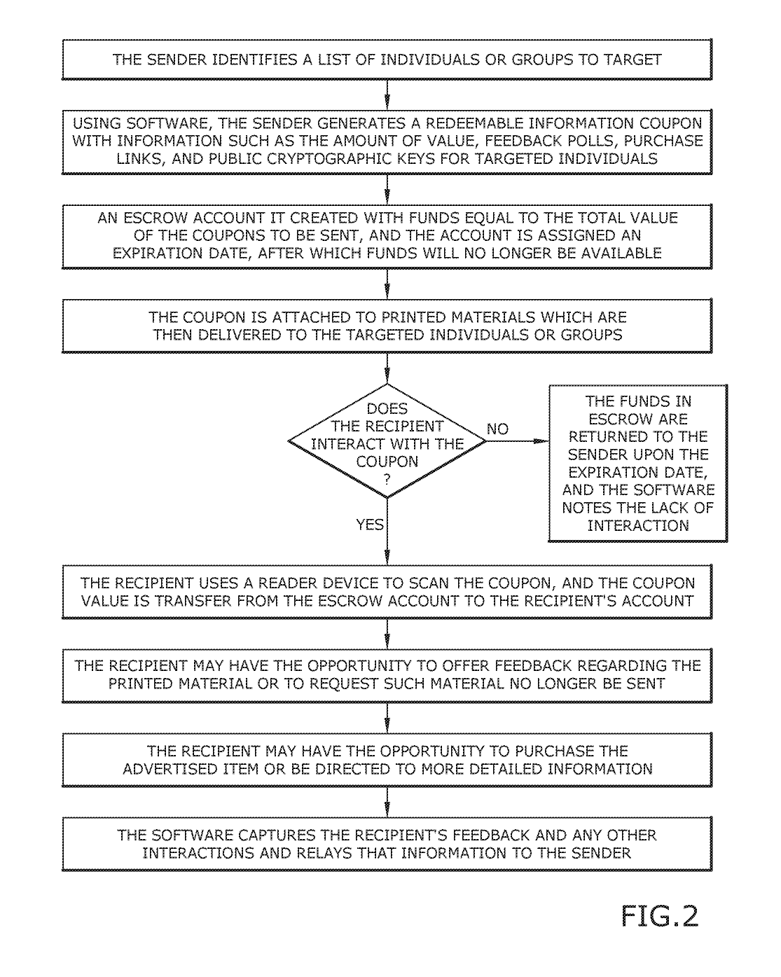

Referring to FIG. 2, the present invention includes a method of advertising a product or service. The steps of the method may include the following. The sender identifies a list of individuals or groups to target. Using software and a computer, the sender generates a redeemable information coupon with information such as the amount of value, feedback pools, purchase links, and public cryptographic keys for targeted individuals. An escrow account is created with funds equal to the total value of the coupons to be sent, and the account is assigned an expiration date, after which funds will no longer be available. The coupon is attached to a printed material which is then delivered to the targeted individuals or groups. If the recipient does not interact with the coupon within a certain period of time, the funds in escrow are returned to the sender upon the expiration date, and the software notes the lack of interaction. Alternatively, the recipient uses a reader device to scan the coupon, and the coupon value is transferred from the escrow to the recipients account. The recipient may have the opportunity to offer feedback regarding the printed material or to request such material no longer to be sent. The recipient may have the opportunity to purchase the advertised item or be directed to more detailed information. The software captures the recipient's feedback and any other interactions and relays that information to the sender.

For exemplary purposes, the code may include a transfer payment of 5¢. Once receiving the printed advertisement, a user collects the 5¢ reward simply by scanning it. At that point, the user can also tell system whether she likes or dislikes the advertisement. The software used to scan the advertisement can request a short survey before releasing the 5¢. Alternatively, the recipient could even conduct a transaction immediately through vendor, analogous to a “buy-it-now” option, because the vendor is already set up to handle the accounting. Such a system fully addresses each of the disadvantages of traditional print ads.

The following is an example in which the United States Postal Service (USPS) uses the present invention. USPS can issue a new type of stamp that not only covers postage but also includes an escrowed amount of money for the recipient. The USPS (or alternate platform) can escrow the funds from senders, illustrated here as 2¢, as well as handle all data associated with consumer location and consumer preferences. If a recipient expresses a desire not to receive future mailings from a particular mailer or on a specific topic, then the platform can take action to dissuade further contact from this sender or on this topic. For example, such mail could be embargoed or the reward could be raised to higher levels such as 5¢ or even $2. By contrast, if a recipient expresses positive interest in a given topic the platform could reduce the RIC to 0, share this information with mailers, and encourage new mail on this topic. In this fashion, the future mail stream of a given recipient quickly adapts to the express preferences of that recipient.

The following is an example of a Credit Card company using the present invention. One challenging bank problem is the high cost of acquiring a new credit card customer. Standard mail remains one of the best options for placing content in the hands of a consumer but recipients frequently discard offers unopened. In exchange for a 4¢ coupon, a bank could learn whether a customer likes the offer or dislikes specifics such as the interest rate or the annual fee. If a customer likes an offer, the card could be issued immediately because the user is already authenticated—only that user can redeem it. For a mere 4 extra cents, either the bank has learned what the offer lacks in appeal or the bank has succeeded in issuing the credit card. The bank gains information or an immediate transaction. If a customer ignored a 4¢ offer, the bank could try a 10¢ offer, and learn the “reservation price” for getting customer attention. Importantly, if the consumer discards any advertisement, the digital cash simply expires, and the bank can reuse the reward to approach a different customer. In that case, the extra cost is nothing.

The following is an example of how the present invention promotes viral advertisements. A new restaurant opens and wishes to reach prospective patrons in its neighborhood. The restaurant runs a standard mail campaign, setting an 8¢ offer to gather information on whether the prospect likes the food being served at the restaurant. The restaurant could also set an offer to reward a recipient for forwarding the offer to someone who does like the food being offered by the restaurant within a geographic radius. By rewarding the original recipient as well as her friends, the advertisement becomes self-propagating. Further, the offer could include a 20% discount off the first meal in order to drive traffic. From a user's perspective, original print offers can be automatically collected and archived for later use. Bulk inserts from mailers and Sunday circulars gain added impact as recipients distribute them to friends and do not lose coupons they collect. Data also provides a trace of how advertisements move through a community. This greatly facilitates A/B testing of ad campaign efficacy.

The following is an example of how the present invention may be used for new homeowners. Registering a new property automatically triggers a flood of solicitations for the new homeowner. Offers include carpeting, insurance, maid service, gutter cleaning, home furnishings, etc. If the homeowner doesn't need any of these but does need new window treatments, the present invention can work in reverse based on customer requests. Bi-directional flows enable both push and pull marketing. A serious homeowner can buy a coupon, reversing the reward to sellers of window treatments. Now the seller(s) can mail an expensive catalog or physical sample instead of the cheap circular. When catalogs weighed more than a pound, firms like SEARS®, SPIEGEL®, MONTGOMERY WARD®, and JC PENNEY® would charge consumers $5 to cover costs, and then refund it, often as $10, on the first purchase. Similarly, people receiving a “catalog of catalogs” often paid $1 to get a high quality glossy mailing of their choice. Reversing the present invention allows the consumer to request expensive printed materials at the same time it pre-qualifies the recipient as a high probability buyer. Any type or number of merchants, in this case seller of window treatments, could set up shop on the platform of the present invention to use both print and digital distribution channels. The platform of the present invention can also facilitate transactions between buyer and seller, allowing the platform sponsor to earn transaction fees.

The following is an example of how the present invention gathers non-subscriber information. A major publisher such as NORTON® advertises with the NEW YORK TIMES® in order to target Times subscribers who might buy a new book. Matching the intended recipients against its subscriber base, the NEW YORK TIMES® sells NORTON® a block of 10¢ such that only Times' subscribers are eligible for the book promotion. The first version of the present invention is also set to expire within a short window, e.g. seven days, in order that sales are easily estimated and budgets easily controlled. A second version of the present, however, targets non-subscribers. When a print version of the Times circulates in an office, in a home or on public transportation, third parties often read it. Until now, getting estimates of readers who are non-subscribers has been very difficult. The present invention solves this problem by instantly identifying whether the person scanning the offer is the target or a third party. While the default might set the redemption value at 0¢ for third parties, redemption could be set to 1¢, 10¢, or even 25¢ in order to gather data on who else is interested. The non-subscriber expiration data can also be lengthened to account for delays in re-circulating the original print edition. Any act of redemption would automatically reveal who else is reading and scanning the advertisement. Both the NEW YORK TIMES® and NORTON® gain valuable new information.

It should be understood, of course, that the foregoing relates to exemplary embodiments of the invention and that modifications may be made without departing from the spirit and scope of the invention as set forth in the following claims.

What is claimed is:

1. A method of advertising a product or service comprising:
generating a computer readable code by a sender via software executing on a first computer, wherein the computer readable code comprises account information of an escrow account;
sending the computer readable code from the sender to at least one recipient;
scanning the computer readable code by the at least one recipient via software executing on a second computer; and
transferring a monetary amount from the escrow account to a recipient account via software executing on a computer.

2. The method of claim 1, wherein the step of sending the computer readable code to at least one recipient comprises the steps of:
printing the computer readable code onto a physical item; and
mailing the physical item to the at least one recipient.

3. The method of claim 2, wherein the physical item comprises a letter.

4. The method of claim 1, wherein the computer readable code further comprises advertising information about a product or service.

5. The method of claim 4, further comprising the step of producing the advertising information about the product or service to the at least one recipient via a display of the second computer.

6. The method of claim 5, wherein the advertising information comprises information about the product or service, an option for the recipient to purchase the product or service, and an option for the recipient to provide feedback of the product or service.

7. The method of claim 6, wherein the option for the recipient to provide feedback of the product or service comprises prompting the recipient to chose if the recipient prefers to continue receiving the advertising information from the sender.

8. The method of claim 1, wherein the computer readable code further comprises an expiration date, wherein if the computer readable code is scanned after the expiration date, the monetary amount is not transferred from the escrow account to the recipient account.

9. The method of claim 1, wherein the at least one recipient is a target recipient.

10. The method of claim 9, wherein the computer readable code comprises verifying information of the target recipient, wherein only the target recipient is able to access the account information of an escrow account and advertising information about the product or service via the computer readable code.

11. The method of claim 1, wherein the computer readable code is a matrix barcode.

12. A system for providing advertisements of a product or service comprising:
a code generator that generates a computer readable code comprising account information of an escrow account;
a code reader that reads the computer readable code; and
a computer operatively connected to the code reader, wherein the computer receives the computer readable code from the code reader and initiates a monetary exchange from the escrow account to a recipient account.

13. The system of claim 12, wherein the computer comprises a display

14. The system of claim 13, wherein the computer readable code further comprises advertising information about a product or service, wherein the computer produces the advertising information about the product or service on the display after the computer receives the computer readable code from the code reader.

15. The system of claim 14, wherein the advertising information comprises information about the product or service, an option for the recipient to purchase the product or service, and an option for the recipient to provide feedback of the product or service.

16. The system of claim 15, wherein the computer prompts a recipient to choose if the recipient prefers to continue receiving the advertising information.

17. The system of claim 12, wherein the computer readable code further comprises an expiration date, wherein if the code reader reads the computer readable code after the expiration date, the monetary amount is not transferred from the escrow account to the recipient account.

18. The system of claim 12, wherein the computer readable code is a matrix bar code.
